(19) United States
(12) Patent Application Publication
(10) Pub. No.: US 2005/0029954 A1
(43) Pub. Date: Feb. 10, 2005

(54) Plasma processing apparatus and method

(75) Inventors: Shigenobu Yokoshima, Saitama (JP); Yuichi Takamura, Tochigi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 10/910,272

(22) Filed: Aug. 4, 2004

(30) Foreign Application Priority Data
Aug. 6, 2003 (JP) 2003-288255

(51) Int. Cl. H01J 7/24

(52) U.S. Cl. 315/111.21; 315/111.51

(57) ABSTRACT

A plasma-processing apparatus includes a vacuum chamber for accommodating an object to be processed and for providing plasma processing to the object under a vacuum or reduced environment, an impedance matching unit configured for impedance matching, the impedance matching unit being provided between the vacuum chamber and a microwave oscillator for generating microwaves, and a controller for controlling actions of the impedance matching unit based on a relationship among a matching state of the impedance matching unit, a microwave strength distribution necessary to generate plasma for the matching state, and a matching state of the impedance matching unit which minimizes a reflected wave during the plasma processing.

This application claims a foreign priority benefit based on Japanese Patent Application No. 2003-288255, filed on Aug. 6, 2003, which is hereby incorporated by reference herein in its entirety as if fully set forth herein.

### BACKGROUND OF THE INVENTION

The present invention relates generally to plasma processing with microwave-generated plasma, and more particularly a method and apparatus for generating and stabilizing the plasma.

The recent developments of electronic apparatuses have caused increasing demand for manufacturing of high-quality electronic components contained in these electronic apparatuses. To manufacture certain electronic components, such as semiconductor devices, a microwave plasma-processing apparatus is needed for certain processing steps such as coating, etching, and ashing.

The microwave plasma-processing apparatus typically introduces the microwaves from a microwave oscillator into a vacuum chamber or a plasma-processing chamber so as to generate the plasma, and performs plasma processing using the plasma. In generating the plasma by introducing the high-frequency electromagneticwaves, such as the microwaves, into the plasma-processing chamber, as disclosed, for example, in Japanese Patent Application, Publication No. 10-134996, an impedance matching unit for matching with a load side is provided on a waveguide between the plasma-processing chamber and the high-frequency source.

The impedance matching unit serves to automatically search for and maintain a matching position that has a matching state for minimizing the reflected waves (microwaves) in the plasma-processing chamber during the plasma processing so that all the microwaves projected to the plasma-processing chamber are consumed for the plasma generation.

The conventional impedance matching unit can stably maintain the plasma once it determines the matching position. However, the unit has some problems in that: (1) it cannot generate the plasma steadily and quickly; (2) it cannot always maintain the once generated plasma until the time the matching state is equal to the matching position; and (3) a change from the plasma generation state to the matching position is not always along the most direct route.

As a result of inventors' studies of these problems, they have found that: (1) a matching state that can generate the plasma is not always identical to the matching position and reaches the matching position after certain straying; (2) after the plasma is generated, the unit can pass through a matching area that destabilizes or extinguishes the plasma; and (3) the impedance matching unit transfers while searching for the matching position. These problems result from the facts that the conventional impedance matching unit operates without recognizing: (1) a matching state that can generate the plasma, (2) a matching area that destabilizes or extinguishes the plasma, and (3) a matching position, etc.

As a consequence, there occur some problems: (1) The plasma is not generated if the matching state range that can generate the plasma is narrow, (2) an area that destabilizes or extinguishes the plasma cannot stably maintain the plasma, if this matching area is located between the matching state that can generate the plasma and the matching position for the generated plasma, and (3) insufficiently matched, irregular plasma occurs for a long period of time.

When the plasma is not generated quickly, the microwave radiation electrically damages and disadvantageously heats an object to be processed, preventing the high-quality processing of the object. For example, when the object is a semiconductor device, the radiated microwaves destroy the structure in the semiconductor device and deteriorate its characteristics.

In addition, the unstable plasma and the long period of time to reach the matching position cause the irregular plasma to generate and damage the object. In particular, when the object is a semiconductor device, contacts of the irregular plasma with the object destroy the structure in the semiconductor device and deteriorate its characteristics because of the high energy (potential) of the irregular plasma.

Moreover, before the matching state reaches the matching position after the plasma is generated, it passes through a matching state that makes the plasma unstable. The matching state requires a long period of time to reach the matching position due to the unstable plasma or it will become an unstable state called hunting. The unstable plasma damages the object as discussed above, and applies an excessive load to the plasma-processing apparatus, thereby causing damage and breakdown of the apparatus.

### BRIEF SUMMARY OF THE INVENTION

Accordingly, in order to solve the prior art problems, it is an exemplary object of the present invention to provide a plasma-processing apparatus and method for generating the plasma steadily and quickly, and for stabilizing and maintaining the once generated plasma until the matching state reaches the matching position.

A plasma-processing apparatus according to one aspect of the present invention includes a vacuum chamber for accommodating an object to be processed and for providing plasma processing to the object under a vacuum or reduced environment, an impedance matching unit configured for impedance matching, the impedance matching unit being provided between the vacuum chamber and a microwave oscillator for generating microwaves, and a controller for controlling actions of the impedance matching unit based on a relationship among a matching state of the impedance matching unit, a microwave strength distribution necessary to generate plasma for the matching state, and a matching state of the impedance matching unit which minimizes a reflected wave during the plasma processing.

Thus, the present invention can provide a plasma-processing apparatus and method for generating the plasma steadily and quickly, and for stabilizing and maintaining the once generated plasma until it reaches the matching position.

### BRIEF DESCRIPTION OF THE DRAWINGS

FIG. 1 is a flowchart showing a plasma-processing method according to one embodiment of the present invention, which is a control method over an impedance matching unit, which generates the plasma at a plasma producible position, then reaches a matching position, and performs plasma processing.

FIG. 2 is a flowchart showing a plasma-processing method according to another embodiment of the present invention, which is a control method over an impedance matching unit, which generates the plasma at a matching position, and performs plasma processing.

FIG. 3 is a flowchart showing a plasma-processing method according to still another embodiment of the present invention, which is a control method over an impedance matching unit, which generates the plasma at a plasma producible position substantially close to a matching position, then reaches the matching position, and performs plasma processing.

FIG. 4 is a flowchart showing a plasma-processing method according to still another embodiment of the present invention, which is a control method over an impedance matching unit, which generates the plasma at a plasma producible position, then reaches a matching position through a certain set route, and performs plasma processing.

FIG. 5 is a flowchart showing a plasma-processing method according to still another embodiment of the present invention, which is a control method over an impedance matching unit, which activates a microwave oscillator at a state of a reflection coefficient of 1 of the impedance matching unit, then generates the plasma via a plasma producible position, reaches a matching position, and performs plasma processing.

FIG. 6 is a schematic block diagram of a structure of a plasma-processing apparatus according to one embodiment according to the present invention.

FIG. 7 is a Smith chart showing a relationship measured by the plasma-processing apparatus shown in FIG. 6, among matching states of the impedance matching unit, microwave strengths necessary for plasma generation at these matching states, and matching positions.

FIG. 8 is a Smith chart different from FIG. 7.

### DETAILED DESCRIPTION OF THE PREFERRED EMBODIMENTS

First Embodiment

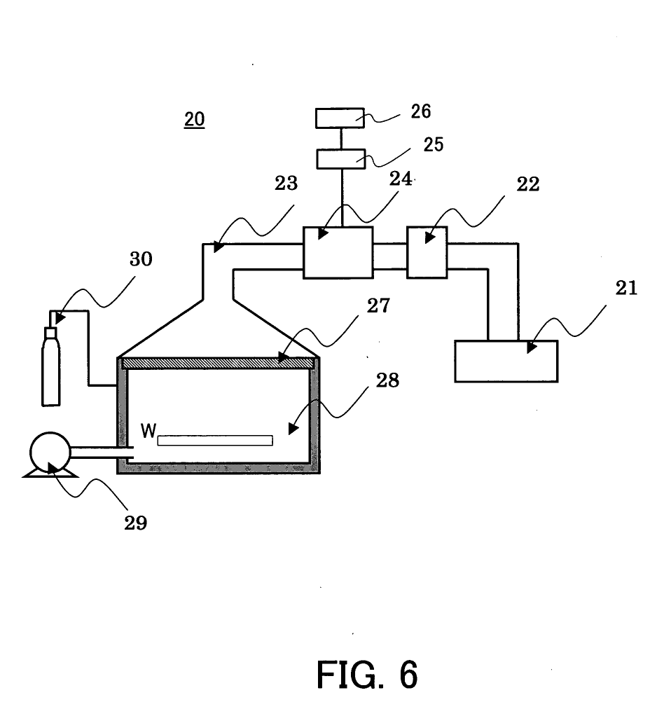

A description will now be given of a plasma-processing apparatus and method according to a first embodiment according to the present invention, with reference to the accompanying drawings. FIG. 6 shows a schematic block diagram of a structure of an inventive plasma-processing apparatus 20. The plasma-processing apparatus 20 includes a microwave oscillator 21, an isolator 22, a microwave waveguide 23, an impedance matching unit 24, a controller 25, a memory 26, a separation means 27, a vacuum chamber 28, a vacuum exhaust means 29, and a gas supply means 30.

The microwave oscillator 21 includes, for example, a magnetron, and generates microwaves, for example, of 2.45 GHz. The microwaves are then converted by a mode converter into a TM, TE or TEM mode or the like, before propagating through the microwave waveguide 23. The isolator 22 prevents microwaves reflected on the waveguide etc. from returning to the microwave oscillator 21 by absorbing the reflected waves.

The separation means 27 seals the vacuum chamber 28, and introduces the microwaves into the vacuum chamber 28. The separation means 27 includes, for example, a dielectric plate as an isolative material. If necessary, a multi-slot antenna (“PMA”) using a endless annular waveguide, a radial line slot antenna (“RLSA”) or another antenna member is provided between the dielectric plate and the microwave waveguide 23.

The vacuum chamber 28 is a process chamber that accommodates the object W and provides a plasma treatment, such as coating, etching and ashing, to the object W under a reduced pressure or vacuum environment. FIG. 6 omits a gate valve that receives the object W from and feeds the object W to a load lock chamber (not shown), and the like.

The vacuum exhaust means 29 maintains the predetermined pressure by exhausting the vacuum chamber 28. The vacuum exhaust means 29 includes, for example, a turbo molecular pump (TMP), and is connected to the vacuum chamber 28 via a pressure control valve (not shown), such as a conductance valve (not shown).

The gas supply means includes a gas source, a valve, a mass flow controller, and a gas supply route that connects them, and supplies reactive gas (such as NH₃ and NO) and discharge gas (such as Xe and Ar) to be excited by the microwaves in order to obtain the predetermined plasma.

The impedance matching unit 24, which is made of an EH tuner, a stab tuner, etc., includes a power meter that detects the strength and phase of each of a progressive wave supplied from the microwave oscillator 21 to the load and a reflected wave that is reflected by the load and returning to the microwave oscillator 21, and serves to match between microwave oscillator 21 and a load side.

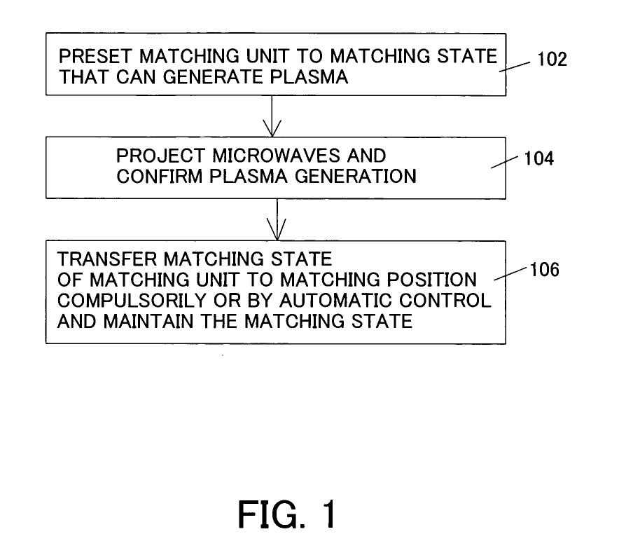

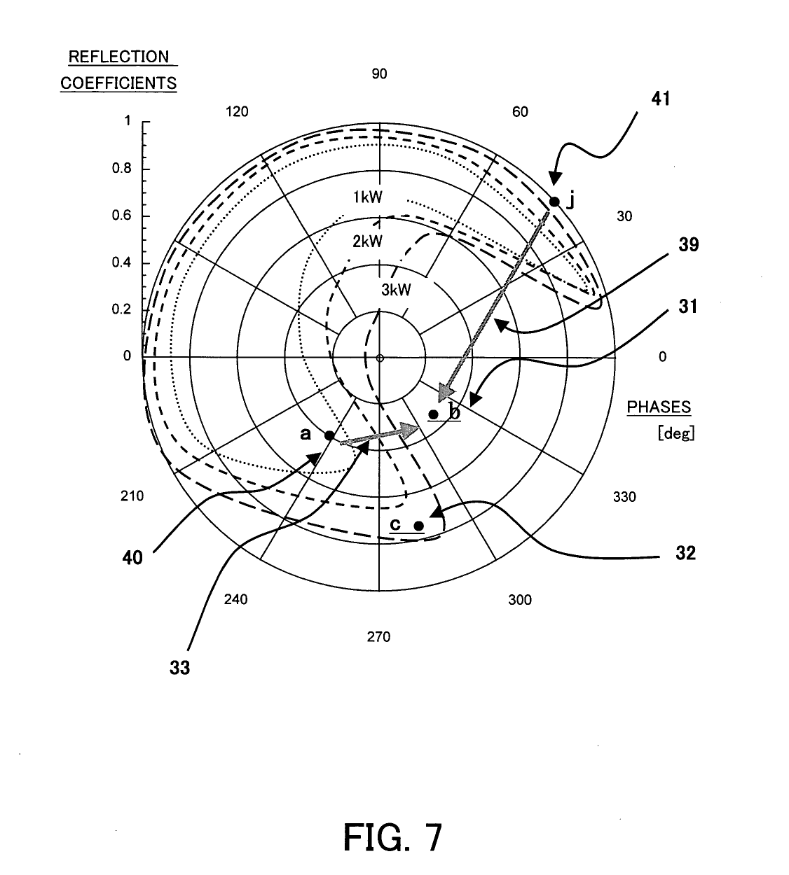

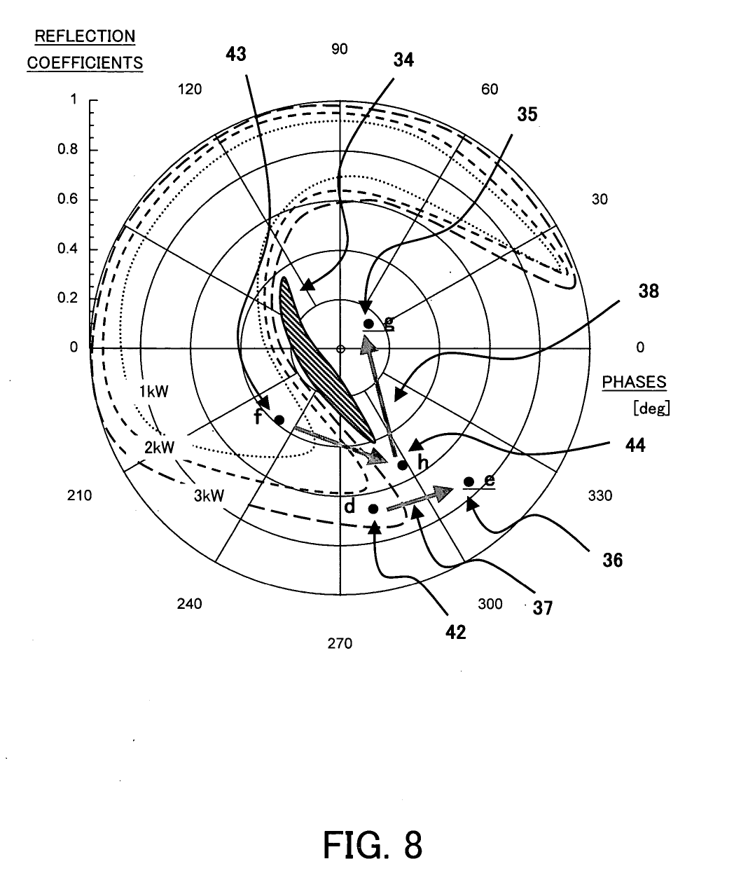

The controller 25 controls each component in the plasma-processing apparatus 20 but particularly controls, in the instant embodiment, impedance matching by the impedance matching unit 24 based on data stored in the memory 26 (a relationship which will be described later with reference to FIGS. 7 and 8 and the plasma-processing method which will be described with reference to FIGS. 1-5).

The memory 26 stores a relationship among a matching state of said impedance matching unit 24, a microwave strength distribution necessary for plasma generation for the matching state, and the matching state of the impedance matching unit 24, which minimizes a reflected wave during the plasma processing. More specifically, the memory 26 stores a Smith chart which will be described with reference to FIGS. 7 and 8, or a chart that uniquely corresponds to the Smith chart. The memory 26 also stores the plasma-processing method of the instant embodiment shown in FIGS. 1 to 5.

For characteristic impedance determined by a load state, such as the plasma state in the vacuum chamber 28 and microwave waveguide 23, the impedance matching unit 24 changes its own characteristic impedance, and adjusts the entire impedance, and restrains generations of reflected waves of the microwaves projected. This function of the impedance matching unit 24 enables the plasma generations to consume all the microwaves projected in the vacuum chamber 28. More specifically, the impedance matching detects the strengths and phases of the reflected waves of the microwave input from the load side of the impedance matching unit 24 and attempts to minimize the reflected waves. After the plasma occurs, it is the matching state that minimizes the reflected wave that becomes a matching position for the impedance matching unit 24.

FIG. 7 illustrates matching states of the impedance matching unit 24 observed by the plasma-processing unit 20 and a microwave strength distribution necessary to generate the plasma for these matching states. FIG. 7 uses a Smith chart to indicate the matching state of the impedance matching unit 24, and shows areas that can generate the plasma using the microwaves of 1 kW to 3 kW in the vacuum chamber 28 for phases and reflection coefficients of the reflected waves of the microwaves formed by the impedance matching unit 24. Positions b31 and c34 are matching positions that minimize the reflected waves from the load, when the plasma generated from the microwaves of 1 kW and 3 kW becomes steady. FIG. 7 particularly illustrates that oxygen exists at 1 Torr in the vacuum chamber 28. The microwave strength distribution necessary to generate the plasma shown in FIG. 7 etc. greatly vary according to the structure of the plasma-processing unit 20, gas types and pressures for generating the plasma, and do not limit the present invention.

Understandably, while an original object of the impedance matching unit 24 is to restrain microwaves' reflected waves and stably maintain the plasma, as discussed, the matching state is also extremely important to the plasma generating process, as shown in FIG. 7. In short, as shown in FIG. 7, an output of the microwaves necessary to generate the plasma is determined by the matching state of the impedance matching unit 24. There is a plasma producible position that can generate the plasma using the microwaves at a low output, whereas there is a state that cannot generate the plasma even using the microwaves at a high output. On the other hand, it is understood that a position b31 as the matching position is not necessarily located at a position of a matching state that can easily generate the plasma.

As shown in FIG. 7, when the matching position is not located at a position of the matching state that can easily generate the plasma, the impedance matching unit 24 does not ideally operate for the plasma process using intermittent microwaves.

In other word, the impedance matching unit 24 is located, during the plasma processing, at the matching position suitable for the plasma processing, which is, for example, at the position b31. If the supply of the microwaves stops and then resumes, the impedance matching unit 24 needs to detect a re-projection of the microwaves, transfer from the matching position to the matching state that can generate the plasma, and then return to the matching position. There is a certain time delay from the microwave projection to the plasma generation, and this delay causes the object W to be disadvantageously subject to the microwaves during this period. When the plasma occurs away from the matching position, the irregular plasma damages the object W during the time the impedance matching unit 24 reaches the matching position.

On the contrary, according to the instant embodiment which will be described later, the controller 25 measures and stores relationships shown in FIGS. 7 and 8 in a memory 26 so as to determine the processing conditions suitable for the plasma-processing apparatus 20 used for the plasma processing, and then controls the matching state of the impedance matching unit 24 based on the relationship. Thereby, the instant embodiment minimizes influence of the microwaves and of the irregular plasma onto the object W. The shortened time to stabilize the plasma can minimize the damage to the object W and improve the process efficiency.

While the instant embodiment shows an exemplary means for indicating the matching state of the impedance matching unit 24 on the Smith chart, the alternative embodiment can measure a relationship between mechanical positions etc. of the impedance matching unit 24 and the microwave output necessary for the plasma generation, and takes advantage of the result. Control based on the mechanical positions of the impedance matching unit 24 is preferable, especially to change the matching state from the plasma producible position to the matching position in the shortest time. Similar effects are available when the matching state of the impedance matching unit is indicated on the chart that uniquely corresponds to the Smith chart.

Referring now to FIG. 1, a description will be given of a plasma-processing method that uses data shown in FIG. 7. FIG. 1 is a flowchart showing a plasma-processing method according to one embodiment of the present invention, which is a control method diagram over an impedance matching unit 24, which generates the plasma at a plasma producible position, then reaches the matching position, and performs the plasma processing.

For the plasma processing using the microwave at an output of 1 kW, it has been conventionally necessary that the impedance matching unit reach a matching state that can generate the plasma at 1 kW by a certain searching action so as to generate the plasma, and then reaches the matching state b31 at 1 kW shown in FIG. 7.

On the other hand, the instant embodiment previously stores the distribution shown in FIG. 7 in the memory 26. In the actual plasma processing, the controller 25 presets a matching state of the impedance matching unit 24 to a position a40 or one position in the matching state that can generate the plasma at 1 kW (step 102), and then controls the microwave oscillator 21 to generate the plasma steadily (step 104). This system can generate the plasma quickly and reduce the direct irradiation amount from the microwaves onto the object W before the plasma is generated. Next, the controller 25 controls the impedance matching unit 24 so that the matching state transfers from the position a40 to the matching position b31 through a transfer route 33 (step 106). Thereby, it is possible to minimize the microwaves to be irradiated onto the object W before the plasma is generated, and provide plasma processing with steadily generated plasma.

For a quick plasma generation, the position a40 as the matching state for the plasma generation preferably has a position that can generate the microwaves at a lower output.

One method for transferring the matching state from the position a40 for the plasma generation to the matching position b31 via the transfer route 33 includes the steps of previously storing the matching position b31 in the memory 26, and compulsorily transferring the matching state to the matching position b31 after the plasma is generated. When the matching position fluctuates due to gas generated from the object W, etc., an alternate method is available which switches the impedance matching unit 24 to the automatic control after the plasma is generated so that the automatic control transfers the matching state to the matching position (step 106).

Second Embodiment

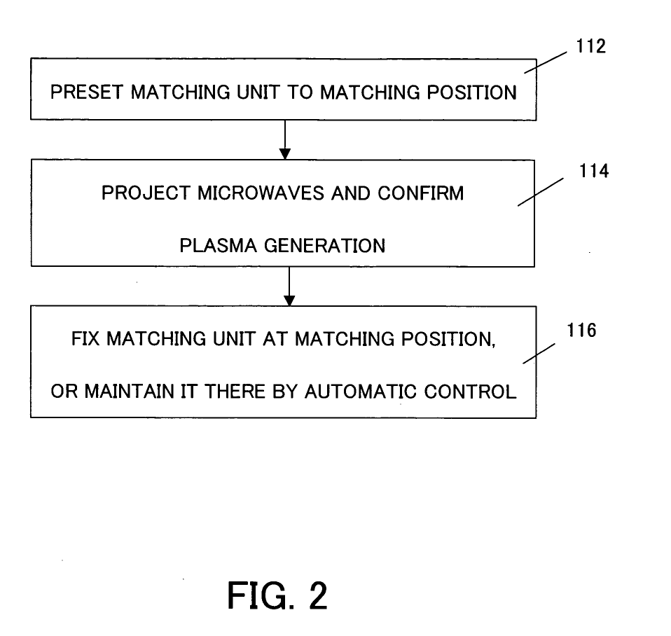

When the apparatus featured as shown in FIG. 7 uses the microwaves at an output of 3 kW for plasma processing, the controller 25 presets the impedance matching unit 24 to a matching state in an area that can generate the plasma at 3 kW as shown by a broken line in FIG. 7, thereby steadily generating the plasma similar to the first embodiment. On the other hand, especially in FIG. 7, when the matching position c32 for 3 kW is included in the area that can generate the plasma at 3 kW, the plasma is generated more steadily and becomes stable. In other words, the plasma becomes steady as soon as it is generated, by presetting the impedance matching unit to the matching position c32, and reduces damage to the object by irregular plasma that may occur during the transfer to the matching position. FIG. 2 shows this control flow.

Referring to FIG. 2, the distribution shown in FIG. 7 and the matching position c32 for 3 kW are measured and stored in the memory 26. In this case, it is confirmed that the matching position c32 is included in the area that can generate the plasma at 3 kW. In the actual plasma processing, the controller 25 presets the impedance matching unit 24 to the matching position c32 as one point in the matching state that can generate the plasma at 3 kW (step 112), and then controls the microwave oscillator 21 to steadily generate the plasma (step 114). This system generates the plasma quickly and reduces a radiation of the microwaves directly onto the object W.

The stable plasma provides good plasma processing if the matching state is set to the matching position c32. When the matching position changes due to gas generated from the object to be processed, an alternative method is available which switches the impedance matching unit to an automatic control mode after the plasma is generated at the matching position c32, and allows the automatic control to minimize the reflected waves (step 116).

Third Embodiment

Alternatively, the controller 25 may generate the plasma at an output lower than the microwave's output used for the processing, maintain the good matching state of the impedance matching unit 24, enhance the originally desired microwave's output, and conduct the plasma processing. In other words, this embodiment stabilizes the plasma using the manipulations shown in FIG. 1 by controlling the microwave oscillator 21 while the impedance matching unit 24 is set to the matching state that can generate the plasma at an output (for example, 1 kW) lower than the microwave's output (for example, 3 kW) used for the processing, and starts plasma processing by projecting the microwaves of 1 kW. Then, the plasma processing may follow by increasing the microwaves up to 3 kW while the impedance matching unit 24 keeps minimizing the reflected waves. This system can reduce the direct irradiations of microwaves upon the object before the plasma is generated. This is achieved by projecting the plasma quickly using low-output microwaves processing the plasma using high-output microwaves. This system can also reduce damage to the object by the irregular plasma.

Fourth Embodiment

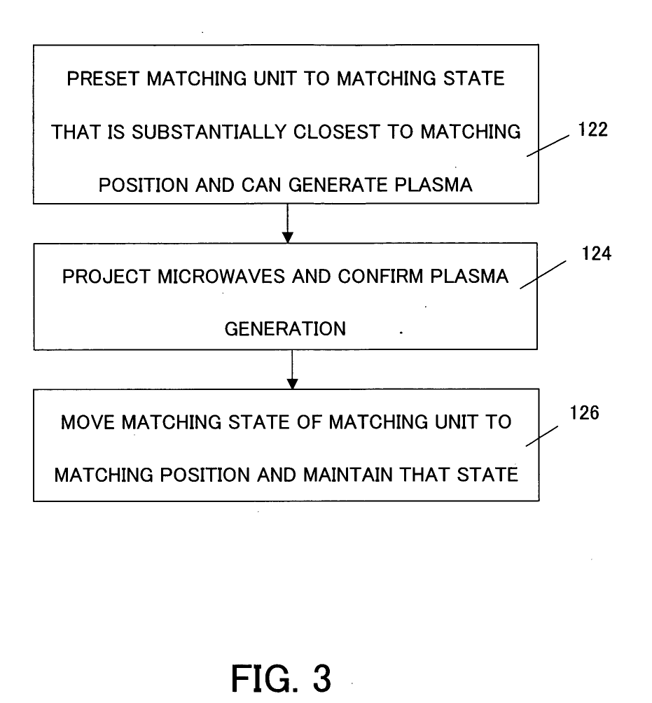

Referring to FIGS. 3 and 8, a description will be given of plasma processing as a variation of the above first embodiment. Here, as a variation of FIG. 1, FIG. 3 is a flowchart showing a control method over an impedance matching unit. FIG. 3 generates the plasma at the plasma producible position substantially closest to the matching position, then transfers the matching state to the matching position, and performs the plasma processing. Particularly good plasma processing is possible by generating the plasma at a position within 120% of a minimum distance between the matching position and the plasma producible position.

FIG. 8, which is different from FIG. 7, is the matching state of the impedance matching unit 24 and a corresponding strength distribution of microwaves necessary to generate the plasma. In FIG. 8, a position e36 is a matching position for the microwaves at an output of 3 kW. A position d42 is within an area that can generate the microwaves at an output of 3 kW, and is located sufficiently close to the above matching position e36.

In FIG. 8, for example, when the plasma processing uses the microwaves at an output of 3 kW, the plasma cannot occur at the position e36 as the matching position for 3 kW. Therefore, as discussed, it is effective that the controller 25 presets the impedance matching unit 24 to the matching state that can generate the plasma. By setting the plasma producible position at a position, for example, the position d42, which is substantially closest to the matching position e36 and has the matching state that can generate the plasma at 3 kW, the controller 25 can make shortest a transfer route 37 for the matching state to transfer to the matching position e36 after the plasma is generated, and prevent damages of the object W by the irregular plasma generated before the matching state is reached. FIG. 3 shows this control flow.

Referring to FIG. 3, a distribution shown in FIG. 8 is previously measured and stored in the memory 26. In the actual plasma processing, the controller 25 presets the matching state of the impedance matching unit 24 to the position d42 or a position substantially closest to the matching position e36 as one point in the matching state for generating the plasma at 3 kW (step 122). Then, control over the microwave oscillator 24 can generate the plasma steadily (step 124). This system can quickly generate the plasma and reduce the direct irradiation amount upon the object W of the microwaves before the plasma is generated. Next, the controller 25 controls the impedance matching unit 24 so that the matching state transfers from the position d42 to the matching position e36 through the transfer route 37 (step 126). This can minimize the microwaves that are generated before the plasma is generated and irradiated upon the object W, and provide the plasma processing with the steadily generated plasma.

Fifth Embodiment

In this embodiment, a description will be given of a control method over the impedance matching unit 24, which involves a matching state that the plasma once generated becomes extremely unstable and extinguishes. FIG. 8 shows an area 34 having such a matching state where the plasma once generated becomes extremely unstable and extinguishes. FIG. 8 also shows a matching position g35 for the microwave output of 1 kW and a position f43 that can generate the plasma at the lowest output in the instant embodiment.

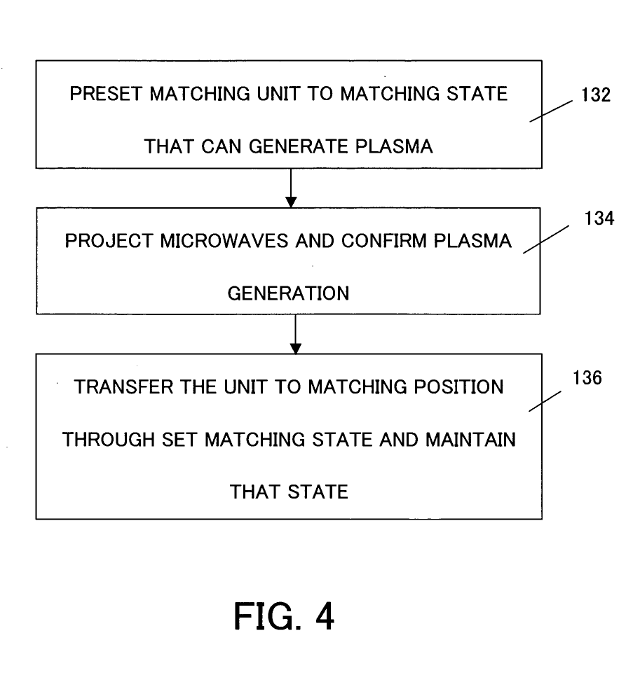

For example, when the plasma processing uses the microwaves at an output 1 kW, it is effective to preset the impedance matching unit 24 to the plasma producible position f43, transfer the unit to the matching position after the plasma is generated, as discussed. However, as shown in FIG. 8, where the area 34 that extinguishes the plasma is located between the plasma producible position f43 and the matching position g35, the plasma disadvantageously extinguishes during transfer if the automatic control or setting directly transfers the matching state to the matching position g35 after the plasma occurs at the position f43. Accordingly, this system secures a smooth transfer to the matching position, as shown by a transfer route 38 in FIG. 8, by generating the plasma, for example, at the position f43 so as to avoid the area 34, and then transfer the impedance matching unit 24 to a position h44, for example, which is another matching state. FIG. 4 shows this control flow.

FIG. 4 is a flowchart as another variation of FIG. 1, showing a control method over the impedance matching state, which provides the plasma processing by generating the plasma at a plasma producible position, and then transferring the matching state to the matching position through a route different from the shortest route.

Referring to FIG. 4, the distribution shown in FIG. 8 is previously measured and stored in the memory 26. In the actual plasma processing, the controller 25 presets the matching state of the impedance matching unit 24 to the position f43 or a position in the matching state that can generate the plasma at 3 kW (step 132), and generates the plasma steadily by controlling the microwave oscillator 21 (step 134). This can generate the plasma quickly and reduce the direct irradiation amount upon the object W of the microwaves generated before the plasma is generated. Next, the controller 25 controls the impedance control unit 24 so that the matching state transfers from the position f43 to the position h44 through the transfer route 38. This system provides the plasma processing by minimizing the microwaves that are generated before the plasma is generated and irradiated upon the object W, and generating the plasma steadily.

In an attempt to stabilize the plasma generation using the control flows shown in FIGS. 3 and 4, an automatic control function of the impedance matching unit can be used to transfer a set position of the matching state just before the matching position to the matching position, and to maintain the matching position.

Sixth Embodiment

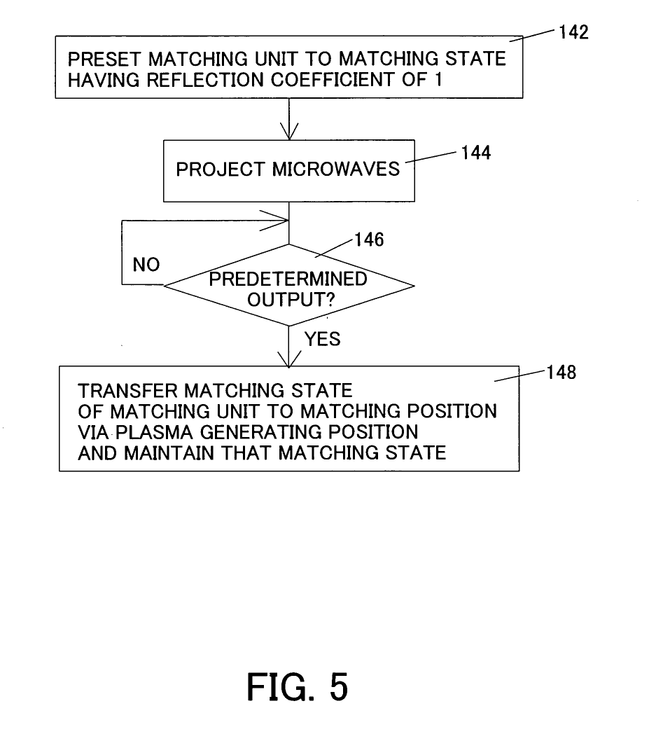

Referring now to FIGS. 5 and 7, a description will be given of plasma processing of another embodiment according to the present invention. Here, FIG. 5 is a flowchart as a variation of FIG. 1, which is a control method over the impedance matching unit 24, which activates the microwave oscillator 21 with a reflection coefficient of 1 of the impedance matching unit 24, then generates the plasma at a plasma producible position, then transfers the matching state to a matching position, and performs plasma processing.

A matching position j41 in FIG. 7 corresponds to the reflection coefficient of 1 on the Smith chart. The matching position j41 includes a matching state that can generate the plasma at 1 kW and is located on a transfer route 39 to the matching position b31 at 1 kW. When the impedance matching unit 24 is set to the matching position j41, the impedance matching unit 24 reflects all the microwaves from the microwave oscillator 21, and no microwaves are supplied to the vacuum chamber 28.

As discussed in the above embodiment, it is useful to prevent irradiations of the microwaves on the object W by presetting the impedance matching unit 24 at a plasma producible position at a predetermined microwave output and generating the plasma steadily. However, even this operation causes the microwave irradiations on the object W, since the plasma does not actually occur before the microwave output from the microwave oscillator 21 becomes a certain level. This is remarkable when an output of the microwave oscillator has a slow activation speed.

Suppose that it takes a longer time for the microwave oscillator 21 to reach a predetermined microwave output than the transfer time of the matching state of the impedance matching unit 24. It is effective for a prevention of the microwave irradiations upon the object W during the activation of the microwave oscillator 21, by manipulating the impedance matching unit 24 to generate and stabilize the plasma after a supply of the microwaves to the vacuum chamber 28 is cut using the impedance matching unit 28. FIG. 5 shows this control flow.

Referring to FIG. 5, the distribution shown in FIG. 8 is measured and stored in the memory 26. In the actual plasma processing, the controller 25 presets the matching state of the impedance matching unit 24 to the position j41 or a position that has a reflection coefficient of 1 (step 142), and then generates the microwaves by controlling the microwave oscillator 21. In this state, the impedance matching unit 24 reflects all the microwaves and the microwaves are not supplied to the vacuum chamber 21. Next, the controller 25 determines whether the microwaves reaches a predetermined output (1 kW in the instant embodiment) based on a power meter provided in the impedance matching unit 24 (step 146).

When the controller 25 determines that it reaches the predetermined output, it controls the impedance matching unit 24 to transfer to the matching position b31 through the plasma producible position and the transfer route 39 (step 148). This configuration prevents the microwave irradiations upon the object during the activation of the microwave oscillator 21, providing steady plasma generation and plasma processing after the microwave output becomes stable.

In order to obtain a relationship between the matching states of the impedance matching unit 24 shown in FIGS. 7 and 8 and the microwave strength distribution necessary to generate the plasma, it is a practical and useful method to determine whether the plasma occurs by sequentially changing the microwave outputs in combinations of reflection coefficients and phases for each impedance matching unit utilizing gas types, pressure and gas flow and the plasma-processing apparatus for use with the plasma processing.

In order to calculate the matching position in each plasma condition, it is practical to obtain a combination of the reflection coefficient and phase of the impedance matching unit 24, which minimizes the reflected waves when the plasma occurs under the condition.

In order to express the matching state of the impedance matching unit, one method can use reflection coefficients and phases expressed on the Smith chart. Similar effects are obtained by expressing the matching state by an actual impedance value and a position of a mechanical part that operates when the impedance matching unit changes the matching state, and by obtaining a relationship between the expressed matching state and microwave output necessary to generate the plasma for the matching state.

A description will now be given of actions of the plasma-processing apparatus 20. As a preliminary stage, the controller 25 obtains the relationship shown in FIGS. 7 and 8 through the measurements and stores them in the memory 26.

In the actual plasma processing, a feed arm (not shown) introduces the object W onto a preheated support stage (not shown) in the vacuum chamber 28 through a gate valve (not shown). In this state, for example, the load lock chamber (not shown) and the vacuum chamber 28 are maintained to be vacuum or at reduced environment. Next, a gate valve (not shown) is closed to seal the vacuum chamber. If necessary, the height of the support stage is adjusted. Next, a valve (not shown) of the gas supply means 28 is opened and predetermined amount of gas is introduced into the vacuum chamber 28 via the mass flow controller.

Next, the controller 25 allows the microwave oscillator 21 to introduce the microwaves into the microwave waveguide 23 and separation means 27. As discussed, the controller 25 controls the impedance matching unit 24 so that the impedance matching unit 24 quickly generates the plasma from the microwaves, and then maintains the matching position. As a result, the object W is not greatly subject to influence of the microwaves and the irregular plasma, and the plasma-processing apparatus 20 provides high-quality plasma processing to the object W.

The plasma processing is conducted for a preset time period. The plasma is generated as soon as the microwaves are projected, and the object W is processed with preset variables (for example, coating with a certain coating thickness). Then, the object W is taken out of the load lock chamber from the vacuum chamber 21 via the gate valve (not shown) by the procedure reverse to the above procedure. The object W taken out of the vacuum chamber 21 is fed, if necessary, to the next ion injector.

As discussed, for smooth plasma generations and transfer to the stable state, the instant embodiments control the matching state of the impedance matching unit by using a distribution diagram that shows a relationship between the previously measured matching state of the impedance matching unit and the microwave output necessary to generate the plasma under the condition. Thereby, the instant embodiment provides reduced microwave irradiations upon the object, prevents negative influence on the object due to the irregular plasma, shortens the processing time, and improves reproducibility of the plasma-processing effects.

1. A plasma-processing apparatus comprising:
a vacuum chamber for accommodating an object to be processed and for providing plasma processing to the object under a vacuum or reduced environment;
an impedance matching unit configured for impedance matching, said impedance matching unit being provided between said vacuum chamber and a microwave oscillator for generating microwaves; and
a controller for controlling actions of said impedance matching unit based on a relationship among a matching state of said impedance matching unit, a microwave strength distribution necessary to generate plasma for the matching state, and a matching state of said impedance matching unit which minimizes a reflected wave during the plasma processing.

2. A plasma-processing apparatus according to claim 1, wherein the relationship is expressed by a Smith chart that indicates an area for generating the plasma for each microwave strength with respect to a phase and a reflection coefficient of a reflected wave of the microwave generated by the impedance matching unit, or a chart that uniquely corresponds to the Smith chart.

3. A plasma-processing apparatus according to claim 2, wherein said controller projects the microwave and generates the plasma while changing a position of said impedance matching unit on the Smith chart and the microwave strength.

4. A plasma-processing apparatus according to claim 1, wherein said controller starts the plasma processing after the microwave is projected, by setting the impedance matching unit to a matching state that can generate the plasma at an output below an output of the microwave used for the plasma processing.

5. A plasma-processing apparatus according to claim 1, wherein said controller starts the plasma processing after the microwave is projected, by setting the impedance matching unit to a matching state that minimizes the reflected wave of the microwave during the plasma processing.

6. A plasma-processing apparatus according to claim 1, wherein said controller starts the plasma processing after the microwave is projected, by setting the impedance matching unit, among the matching states of the impedance matching unit that can generate the plasma at an output of the microwave projected, to the matching state closest to one that minimizes the reflected wave of the microwave during the plasma processing.

7. A plasma-processing apparatus according to claim 1, wherein said controller controls said impedance matching unit so that said impedance matching unit reaches the matching state that minimizes the reflected wave of the microwave through a non-direct route, after said controller projects the microwave while setting the impedance matching unit to a predetermined matching state, and starts the plasma processing.

8. A plasma-processing apparatus according to claim 1, wherein said controller controls said impedance matching unit so that said impedance matching unit reaches the matching state that minimizes the reflected wave of the microwave during the plasma processing via a matching state that can generate plasma using the microwave projected, after an output of the microwave reaches a predetermined output while said controller sets said impedance matching unit to a matching state for total reflection of the microwave from the microwave oscillator and starts supplying the microwave.

9. A plasma-processing apparatus according to claim 1, wherein said controller controls said impedance matching unit so that said impedance matching unit reaches a matching state that minimizes the reflected wave of the microwave during the plasma processing, after said controller presets said impedance matching unit at a matching state that can generate plasma using the microwaves.

10. A plasma-processing apparatus according to claim 1, wherein said controller controls said impedance matching unit so that automatic control transfers said impedance matching unit to a matching state that minimizes the reflected wave of the microwave during the plasma processing, after said controller presets said impedance matching unit at a matching state that can generate plasma using the microwaves.

11. A plasma-processing apparatus according to claim 1, further comprising a memory for storing the relationship.

12. A plasma-processing method for accommodating an object to be processed in a vacuum chamber and for providing plasma processing to the object under a vacuum or reduced environment, said method comprising the steps of:
measuring a relationship among a matching state of an impedance matching unit that is configured for impedance matching and provided between the vacuum chamber and a microwave oscillator for generating microwaves, a microwave strength distribution necessary to generate plasma for the matching state, and a matching state of said impedance matching unit, which minimizes a reflected wave during the plasma processing; and
controlling the impedance matching by said impedance matching unit based on a measurement result obtained by said measuring step.

13. A plasma-processing method according to claim 1, further comprising the step of storing the relationship in a form of a Smith chart that indicates an area for generating the plasma for each microwave strength with respect to a phase and a reflection coefficient of a reflected wave of the microwave generated by the impedance matching unit, or in a form of a chart that uniquely corresponds to the Smith chart.

14. A plasma-processing method according to claim 13, wherein said controlling step projects the microwave and generates the plasma while changing a position of said impedance matching unit on the Smith chart and the microwave strength.

15. A plasma-processing method according to claim 12, wherein said controlling step includes the steps of:
setting the impedance matching unit to the matching state that can generate the plasma at an output below an output of the microwave used for the plasma processing; and
starting the plasma processing by projecting the microwave at the output below the output of the microwave used for the plasma processing.

16. A plasma-processing method according to claim 12, wherein said controlling step includes the steps of:
setting the impedance matching unit to the matching state that minimizes the reflected wave of the microwave during the plasma processing; and
starting the plasma processing by projecting the microwave.

17. A plasma-processing method according to claim 12, wherein said controlling step includes the steps of:
setting, among the matching states of the impedance matching unit that can generate the plasma at an output of the microwave to be projected, the impedance matching unit to the matching state closest to one that minimizes the reflected wave of the microwave during the plasma processing; and
starting the plasma processing by projecting the microwave.

18. A plasma-processing method according to claim 12, wherein said controlling step includes the steps of:
setting the impedance matching unit to a predetermined matching state;
starting the plasma processing by projecting the microwaves; and
controlling the impedance matching unit so that the impedance matching unit reaches the matching state that minimizes the reflected wave of the microwave through a non-direct route.

19. A plasma-processing apparatus according to claim 12, wherein said controlling step includes the steps of:
setting the impedance matching unit to a matching state for total reflection of the microwave from the microwave oscillator;
starting supplying the microwaves;
determining whether an output of the microwave reaches a predetermined output; and
controlling, when said determining step determines that the output of the microwave reaches the predetermined output, the impedance matching unit so that the impedance matching unit reaches the matching state that minimizes the reflected wave of the microwave during the plasma processing via a matching state that can generate plasma using the microwaves projected.

20. A plasma-processing method according to claim 12, wherein said controlling step includes the steps of:
presetting a matching state suitable for the plasma processing in the impedance matching; and
controlling said impedance matching unit so that the impedance matching unit reaches a matching state that minimizes the reflected wave of the microwave during the plasma processing.

21. A plasma-processing method according to claim 12, wherein said controlling step includes the steps of:
presetting the impedance matching unit at a matching state that can generate plasma using the microwaves; and
controlling the impedance matching unit so that automatic control transfers the impedance matching unit to a matching state that minimizes the reflected wave of the microwave during the plasma processing.
